(19) United States
(12) Patent Application Publication
(10) Pub. No.: US 2015/0220873 A1
(43) Pub. Date: Aug. 6, 2015

(54) EXPEDITED SERVICE PROVISIONING ARCHITECTURE

(71) Applicant: Verizon Patent and Licensing Inc., Basking Ridge, NJ (US)

(72) Inventors: Muhammed Shaphy, Irving, TX (US); Sanjay Manocha, Acton, MA (US); Jagannath K. Rangarajan, Irving, TX (US); Ravi Jindal, Irving, TX (US); Rasesh Maniar, Lewisville, TX (US); Rachyata Kapoor, Wesley Chapel, FL (US); Nityanand Sharma, Tampa, FL (US)

(73) Assignee: Verizon Patent and Licensing Inc., Basking Ridge, NJ (US)

(21) Appl. No.: 14/171,991

(22) Filed: Feb. 4, 2014

(51) Int. Cl. G06Q 10/06

(52) U.S. Cl. CPC G06Q 10/063114

(57) ABSTRACT

A device may receive a provisioning order associated with providing a service to a customer premises. The provisioning order may be based on order information, provided by a technician located on the customer premises, associated with initiating provisioning of the service to the customer premises. The device may identify the provisioning order as a prioritized order. The provisioning order being identified as a prioritized order indicating that the provisioning order is to be processed before a non-prioritized provisioning order. The device may provide an acknowledgement of receipt of the provisioning order based on identifying the provisioning order as a prioritized order. The device may determine provisioning information based on the provisioning order. The provisioning information may include equipment installation or configuration instructions associated with initiating provisioning of the service to the customer premises. The device may provide the provisioning information while the technician is located on the customer premises.

### BACKGROUND

Service provisioning is the process of providing a customer with access to a service (e.g., a telephone service, an internet service, a television service, etc.). Service provisioning may include giving the customer access to a network resource associated with the service (e.g., a system, an application, a database, etc.) based on a customer identity associated with the customer, and/or may include installing, configuring, and/or managing a device (e.g., a computer, a modem, a cable box, etc.), associated with the service, located on a customer premises associated with the customer.

### BRIEF DESCRIPTION OF THE DRAWINGS

FIG. 1 is a diagram of an overview of an example implementation described herein;

FIG. 2 is a diagram of an example environment in which systems and/or methods, described herein, may be implemented;

FIG. 3 is a diagram of example components of one or more devices of FIG. 2;

FIG. 4 is a call flow diagram of an example process for receiving a technician initiated order, associated with providing a service at a customer premises, and processing the technician initiated order in an expedited manner;

FIG. 5 is a flow chart of an example process for receiving a provisioning order and completing provisioning of a service, associated with the provisioning order, in an expedited manner; and

FIGS. 6A and 6B are diagrams of an example implementation relating to the example processes shown in FIG. 4 and FIG. 5.

### DETAILED DESCRIPTION

The following detailed description of example implementations refers to the accompanying drawings. The same reference numbers in different drawings may identify the same or similar elements.

A service technician (herein referred to as a “technician”), associated with a service provider, may travel to a customer premises, associated with a customer of the service provider, for a variety of reasons (e.g., to set up a new service ordered by the customer, to troubleshoot an existing service of the customer, etc.). In some cases, the customer may choose to order an additional service (e.g., a service not associated with causing the technician to travel to the customer premises) while the technician is on the customer premises. However, the technician may be unable to install, configure, and/or provide the additional service while the technician is on the customer premises due to limitations associated with processing the order (e.g., when a customer order takes three days to be processed by the service provider before the service can be provided to the customer, etc.). Implementations described herein may allow a service technician, located on a customer premises, to initiate an order, associated with providing a service to the customer, and may allow provisioning of the service to be completed in an expedited manner (e.g., while the service technician is on the customer premises).

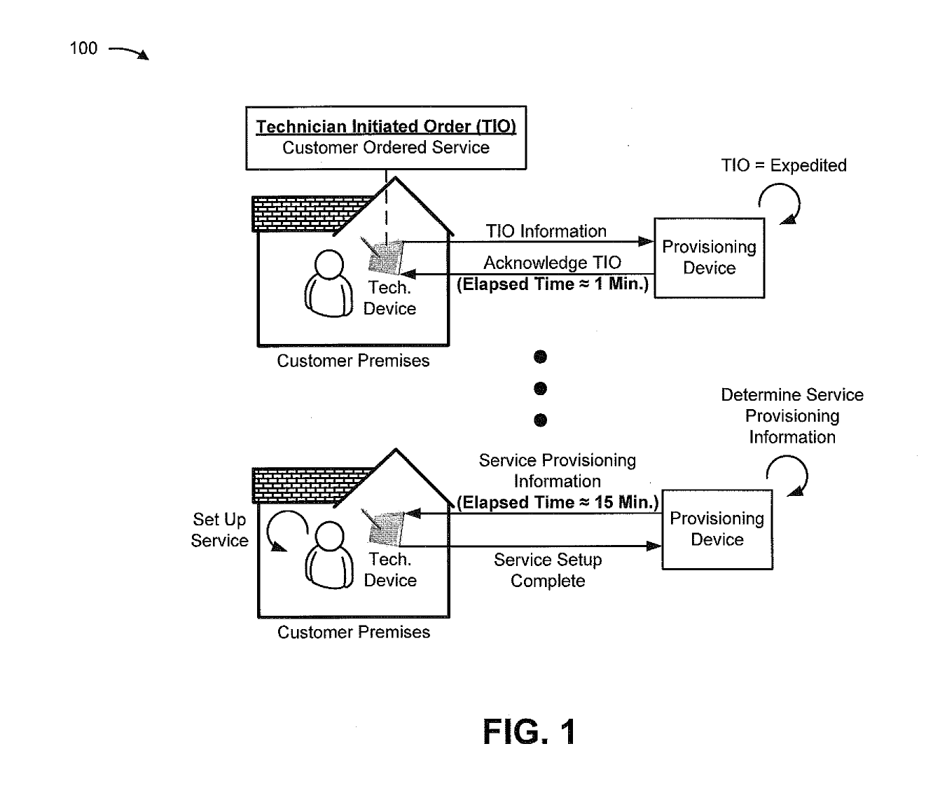

FIG. 1 is a diagram of an overview of an example implementation 100 described herein. For the purposes of FIG. 1, assume that a technician has travelled to a customer premises associated with a customer of a service provider. Further, assume that the customer chooses to order a service (e.g., a service not associated with causing the technician to travel to the customer premises) while the technician is on the customer premises. Finally, assume that a service technician device (herein referred to as a “technician device”), carried by the technician, is configured to provide information associated with ordering the service to one or more other devices associated with the service provider.

As shown in FIG. 1, the technician may input, via the technician device, information associated with a technician initiated order (TIO) that includes information associated with the service ordered by the customer. As shown, the technician device may send (e.g., via one or more devices included in a service provider network) information associated with the TIO to a provisioning device (e.g., a device associated with completing provisioning of the service). As further shown, the provisioning device may receive the TIO information, and may determine that the TIO information is to be processed in an expedited manner (e.g., when the provisioning device is configured to process all TIOs in an expedited manner). As shown, the provisioning device may provide, to the technician device, an acknowledgement of receiving the TIO in an expedited manner (e.g., within approximately one minute of the technician device providing the TIO, within approximately two minutes of the technician providing the TIO, within approximately five minutes of the technician providing the TIO, etc.).

As further shown in FIG. 1, the provisioning device may determine provisioning information (e.g., information associated with installing equipment associated with the service, information associated with configuring equipment associated with the service, etc.), associated with the service in an expedited manner (e.g., within ten minutes of the technician device providing the TIO information, within fifteen minutes of the technician device providing the TIO information, within thirty minutes of the technician device providing the TIO information, etc.), and may provide the provisioning information to the technician device. As shown, the technician may set up the service (e.g., the technician may install and configure equipment associated with the service while the technician is on the customer premises), based on the provisioning information provided by the provisioning device. As further shown, the technician may provide, via the technician device, information indicating that setup of the service is complete, and the technician device may provide the information to the provisioning device. In this way, a service technician, located on a customer premises, may initiate an order, associated with providing a service to the customer, and provisioning of the service may be completed while the service technician is on the customer premises.

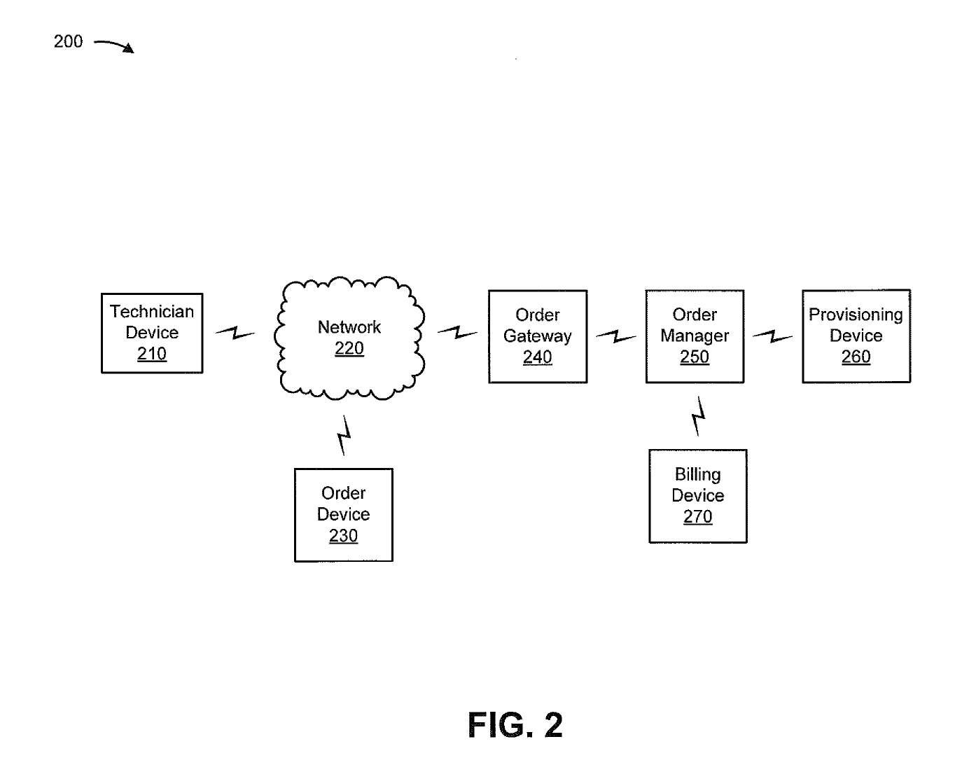

FIG. 2 is a diagram of an example environment 200 in which systems and/or methods described herein may be implemented. As shown in FIG. 2, environment 200 may include a technician device 210, a network 220, an order device 230, an order gateway 240, an order manager 250, a provisioning device 260, and a billing device 270.

Technician device 210 may include one or more devices capable of communicating with other devices (e.g., order device 230, order gateway 240, order manager 250, provisioning device 260, etc.) via a network (e.g., network 220), and/or capable of receiving information provided by another device (e.g., provisioning device 260). For example, technician device 210 may include a wireless communication device, a radiotelephone, a personal communications system (“PCS”) terminal (e.g., that may combine a cellular radiotelephone with data processing and data communications capabilities), a personal digital assistant (“PDA”) (e.g., that can include a radiotelephone, a pager, Internet/intranet access, etc.), a smart phone, a laptop computer, a tablet computer, or a similar type of device. In some implementations, technician device 210 may be capable of receiving a technician initiated order (TIO) associated with a service that is to be provided to a customer of a service provider, and providing the TIO to order device 230. Additionally, or alternatively, technician device 210 may be capable of receiving and/or displaying provisioning information associated with the TIO (e.g., such that a technician, associated with the technician device, may complete provisioning of the service while the technician is on a customer premises).

Network 220 may include one or more wired and/or wireless networks. For example, network 220 may include a cellular network, a public land mobile network (“PLMN”), a local area network (“LAN”), a wide area network (“WAN”), a metropolitan area network (“MAN”), a telephone network (e.g., the Public Switched Telephone Network (“PSTN”)), an ad hoc network, an intranet, the Internet, a fiber optic-based network, and/or a combination of these or other types of networks. In some implementations, network 220 may allow communication between devices, such as technician device 210, order device 230, order gateway 240, order manager 250, provisioning device 260, and/or billing device 270.

Order device 230 may include a device capable of receiving, sending, processing, and/or storing information associated with a TIO received from technician device 210. For example, order device 230 may include a server device. In some implementations, order device 230 may host an application associated with receiving a TIO provided by technician devices 210 and formatting the TIO to create a formatted TIO. Additionally, or alternatively, order device 230 may be capable of providing the formatted TIO to order gateway 240.

Order gateway 240 may include a device capable of receiving, sending, processing, providing, and/or storing information associated with a formatted TIO received from order device 230. For example, order gateway 240 may include a server device. In some implementations, order gateway 240 may host an application associated with creating a service specific TIO based on the formatted TIO. Additionally, or alternatively, order gateway 240 may be capable of providing the service specific TIO to order manager 250.

Order manager 250 may include a device capable of receiving, sending, processing, providing, and/or storing information associated with a service specific TIO received from order gateway 240. For example, order manager 250 may include a server device. In some implementations, order manager 250 may host an application associated with receiving a service specific TIO, creating a provisioning order based on the service specific TIO, and providing the provisioning order to provisioning device 260. In some implementations, order manager 250 may be configured to create a provisioning order only for a particular service or group of services (e.g., another device or group of devices may be configured to process and/or manage service specific orders associated with other services). Additionally, or alternatively, order manager 250 may be capable of managing and/or applying billing information associated with a service specific TIO. Additionally, or alternatively, order manager 250 may be capable of creating billing information, associated with a service and a customer, and providing the billing information to billing device 270.

Provisioning device 260 may include a device capable of receiving, sending, processing, providing, and/or storing information associated with a provisioning order received from order manager 250. For example, provisioning device 260 may include a server device. In some implementations, provisioning device 260 may host an application associated with receiving a provisioning order associated with a service, determining provisioning information (e.g., information associated with installing equipment associated with the service, information associated with configuring the equipment associated with the service) based on the provisioning order, and providing the provisioning information to technician device 210. Additionally, or alternatively, provisioning device 260 may be capable of receiving, from technician device 210, information indicating that an installation and/or a configuration, associated with the service, is complete, and providing information indicating that provisioning of the service is complete.

Billing device 270 may include a device capable of receiving, sending, processing, providing, and/or storing billing information associated with a service provided to a customer. For example, billing device 270 may include a server device. In some implementations, billing device 270 may be capable of receiving, from order manager 250, billing information that indicates that billing device 270 is to begin billing a customer for a service (e.g., after provisioning device 260 indicates, to order manager 250, that provisioning of the service is complete).

The number of devices and networks shown in FIG. 2 is provided for explanatory purposes. In practice, there may be additional devices and/or networks, fewer devices and/or networks, different devices and/or networks, or differently arranged devices and/or networks than those shown in FIG. 2. Furthermore, two or more of the devices shown in FIG. 2 may be implemented within a single device, or a single device shown in FIG. 2 may be implemented as multiple, distributed devices. Additionally, one or more of the devices of environment 200 may perform one or more functions described as being performed by another one or more of the devices of environment 200. Devices of environment 200 may interconnect via wired connections, wireless connections, or a combination of wired and wireless connections.

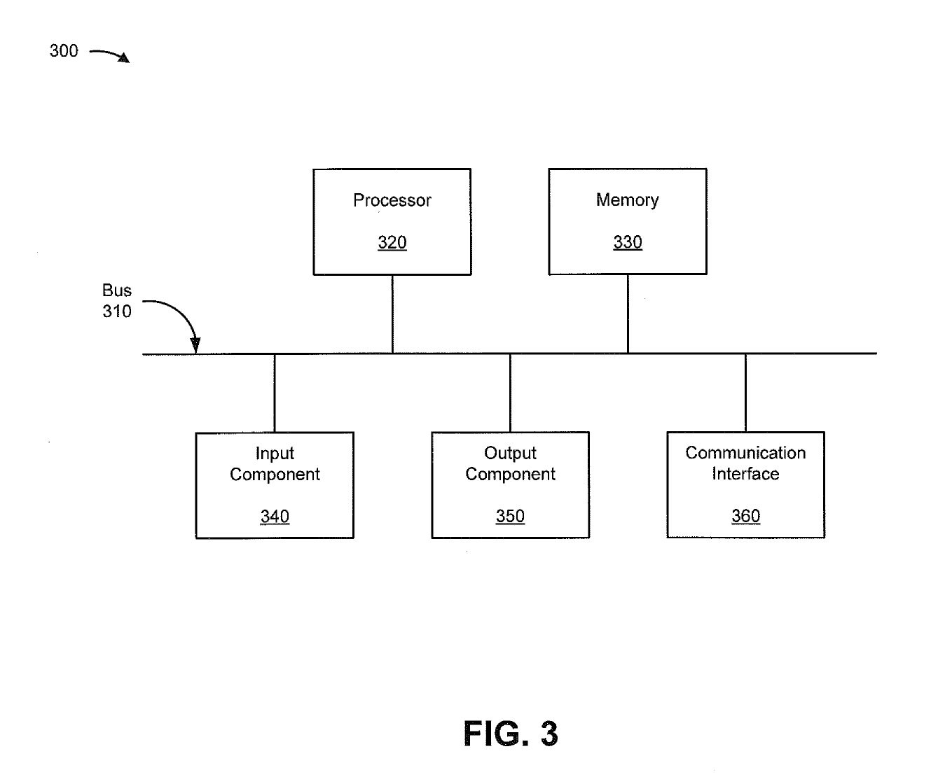

FIG. 3 is a diagram of example components of a device 300. Device 300 may correspond to technician device 210, order device 230, order gateway 240, order manager 250, provisioning device 260, and/or billing device 270. Additionally, or alternatively, each of technician device 210, order device 230, order gateway 240, order manager 250, provisioning device 260, and/or billing device 270 may include one or more devices 300 and/or one or more components of device 300. As shown in FIG. 3, device 300 may include a bus 310, a processor 320, a memory 330, an input component 340, an output component 350, and a communication interface 360.

Bus 310 may include a path that permits communication among the components of device 300. Processor 320 may include a processor, a microprocessor, and/or any processing component (e.g., a field-programmable gate array (“FPGA”), an application-specific integrated circuit (“ASIC”), etc.) that interprets and/or executes instructions. In some implementations, processor 320 may include one or more processor cores. Memory 330 may include a random access memory (“RAM”), a read only memory (“ROM”), and/or any type of dynamic or static storage device (e.g., a flash memory, a magnetic memory, an optical memory, etc.) that stores information and/or instructions for use by processor 320.

Input component 340 may include any component that permits a user to input information to device 300 (e.g., a keyboard, a keypad, a mouse, a button, a switch, etc.). Output component 350 may include any component that outputs information from device 300 (e.g., a display, a speaker, one or more light-emitting diodes (“LEDs”), etc.).

Communication interface 360 may include any transceiver-like component, such as a transceiver and/or a separate receiver and transmitter, that enables device 300 to communicate with other devices and/or systems, such as via a wired connection, a wireless connection, or a combination of wired and wireless connections. For example, communication interface 360 may include a component for communicating with another device and/or system via a network. Additionally, or alternatively, communication interface 360 may include a logical component with input and output ports, input and output systems, and/or other input and output components that facilitate the transmission of data to and/or from another device, such as an Ethernet interface, an optical interface, a coaxial interface, an infrared interface, a radio frequency (“RF”) interface, a universal serial bus (“USB”) interface, or the like.

Device 300 may perform various operations described herein. Device 300 may perform these operations in response to processor 320 executing software instructions included in a computer-readable medium, such as memory 330. A computer-readable medium is defined as a non-transitory memory device. A memory device includes memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes that are described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided for explanatory purposes. In practice, device 300 may include additional components, fewer components, different components, or differently arranged components than those shown in FIG. 3.

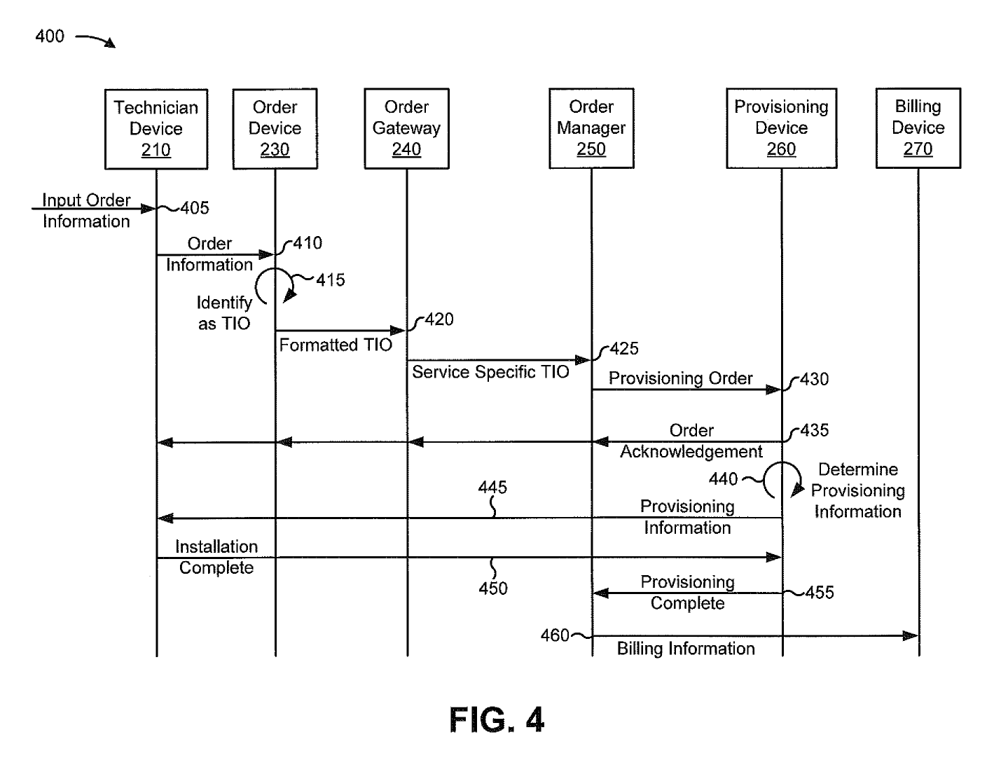

FIG. 4 is a call flow diagram of an example process 400 for receiving a technician initiated order, associated with providing a service, and processing the technician initiated order in an expedited manner. In some implementations, one or more process blocks of FIG. 4 may be performed by one or more devices included in environment 200.

As shown in FIG. 4, process 400 may include receiving order information associated with providing a service to a customer (shown at reference number 405). For example, technician device 210 may receive order information associated with providing a service to a customer. In some implementations, technician device 210 may receive the order information when a technician, associated with technician device 210, provides the order information. For example, the technician may travel to the customer premises, the customer may wish to order a new service (e.g., a service not currently being provided to the customer), and the technician may provide (e.g., via a touch screen, via a keyboard, etc.), to technician device 210, the order information associated with providing the new service.

Order information may include information, provided by a technician located on a customer premises, associated with initiating provisioning of a service to a customer premises device (e.g., a device located on the customer premises). For example, the order information may include information that identifies the customer (e.g., a customer name, a customer identification number, a customer account number, etc.), information that identifies the customer premises (e.g., a street address, a city, a state, a telephone number, etc.), information that identifies a service to be provided (e.g., a name of the service, a service type of the service, etc.), information that identifies a device via which the service is to be provided (e.g., a device identifier, a device type, etc.), or other information associated with providing the service to the customer (e.g., a billing method, a service agreement, etc.). Additionally, the order information may include information (e.g., an indicator, a flag, a tag, a label, etc.) identifying the order as a technician initiated order (TIO) (e.g., an order initiated by a technician while the technician is located on the customer premises).

As further shown in FIG. 4, process 400 may include providing the order information (shown at reference number 410). For example, technician device 210 may provide the order information to order device 230. In some implementations, technician device 210 may provide the order information (e.g., via network 220) to order device 230 when the technician provides the order information to technician device 210 (e.g., after the technician provides the order information) or instructs technician device 210 to provide the order information.

As further shown in FIG. 4, process 400 may include identifying the order information as a technician initiated order (shown at reference number 415). For example, order device 230 may identify the order information as a TIO. In some implementations, order device 230 may identify the order information as a TIO when order device 230 receives the order information from technician device 210.

A technician initiated order (TIO) may include a prioritized order, described by order information (e.g., received from technician device 210) that is to be processed (e.g., by order device 230, by order gateway 240, by order manager 250, by provisioning device 260, etc.) in an expedited manner, such that provisioning of a service, identified in the TIO, may be completed in an expedited manner (e.g., while a technician is on a customer premises after providing the order information). Processing a prioritized order in an expedited manner may include prioritizing the order such that the order is processed approximately immediately after the order is received. For example, the order may be processed in real-time (e.g., as soon as the order is received) or near real-time. As an additional example, the order may be processed in an expedited manner by prioritizing the order such that the order is processed without placing the order in a queue (e.g., when non-prioritized orders are placed in the queue).

In some implementations, order device 230 may identify the order information as a TIO based on information included in the order information. For example, as discussed above, the order information may include information (e.g., an indicator, a flag, a tag, a label, etc.) identifying the order as a TIO, and order device 230 may identify the order information as a TIO based on the order information. Additionally, or alternatively, order device 230 may identify the order information as a TIO based on receiving the order information from technician device 210 (e.g., when order device 230 is configured to identify any order information received from technician device 210 as a TIO).

As further shown in FIG. 4, process 400 may include formatting the order information to create a formatted TIO, and providing the formatted TIO (shown at reference number 420). For example, order device 230 may format the order information, received from technician device 210, to create a formatted TIO, and may provide the formatted TIO. In some implementations, order device 230 may format the order information to create the formatted TIO when order device 230 identifies the order information as a TIO (e.g., after order device 230 identifies the order information as a TIO). Additionally, or alternatively, order device 230 may format the order information to create the formatted TIO when order device 230 receives information, indicating that order device 230 is to create the formatted TIO, from another device (e.g., technician device 210).

In some implementations, order device 230 may format the order information in an expedited manner. For example, order device 230 may identify the order information as a TIO, and may format the TIO to create the formatted TIO approximately immediately after order device 230 identifies the order as a TIO (e.g., in real-time). As an additional example, order device 230 may format the TIO in an expedited manner by prioritizing the TIO such that the formatted TIO is created without placing the TIO in a queue.

A formatted TIO may include order information that has been formatted based on a markup language associated with formatting, encoding, transporting, and/or storing order information, such as extensible markup language (XML). For example, order device 230 may receive the order information, and may create the formatted TIO, based on the order information, in the form of an XML document. In some implementations, order device 230 may format the order information such that each formatted TIO, created by order device 230, uses the same format (e.g., all formatted TIOs may be in the form of an XML document).

In some implementations, order device 230 may create the formatted TIO, and order device 230 may provide the formatted TIO. For example, order device 230 may create the formatted TIO (e.g., after identifying the order information as a TIO) and may provide the formatted TIO to order gateway 240.

As further shown in FIG. 4, process 400 may include creating and providing a service specific TIO based on receiving the formatted TIO (shown at reference number 425). For example, order gateway 240 may create a service specific TIO, based on receiving the formatted TIO from order device 230, and order gateway 240 may provide the service specific TIO. In some implementations, order gateway 240 may create the service specific TIO when order gateway 240 receives the formatted TIO (e.g., after order gateway 240 receives the formatted TIO). Additionally, or alternatively, order gateway 240 may create the service specific TIO when order gateway 240 receives information, indicating that order gateway 240 is to create the service specific TIO, from another device (e.g., order device 230).

In some implementations, order gateway 240 may create the service specific TIO in an expedited manner. For example, order gateway 240 may receive the formatted TIO, and may create the service specific TIO approximately immediately after order gateway 240 receives the formatted TIO (e.g., in real-time). As an additional example, order gateway 240 may create the service specific TIO in an expedited manner by prioritizing the formatted TIO such that the service specific TIO is created without placing the formatted TIO in a queue.

A service specific TIO may include an order, created by order gateway 240, based on information associated with a service included in a formatted TIO. In some implementations, order gateway 240 may create one or more service specific TIOs based on the formatted TIO. For example, order gateway 240 may receive a formatted TIO that identifies a first service (e.g., a data service) and a second service (e.g., a telephone service) that are to be provided to a customer premises. In this example, order gateway 240 may create a first service specific TIO, associated with the first service, and order gateway 240 may create a second service specific TIO associated with the second service. In other words, order gateway 240 may separate the formatted TIO into different service specific TIOs (e.g., when the formatted TIO includes information associated with two or more services).

In some implementations, order gateway 240 may provide the service specific TIO to order manager 250. For example, order gateway 240 may create the first service specific TIO associated with the first service, and may provide the service specific TIO to order manager 250 (e.g., when order manager 250 is configured to process a service specific TIO associated with the first service). In this example, order gateway 240 may create the second service specific TIO, and may provide the second service specific TIO to a device other than order manager 250 (e.g., when the other device is configured to process a service specific TIO associated with the second service).

As further shown in FIG. 4, process 400 may include creating and providing a provisioning order based on the service specific TIO (shown at reference number 430). For example, order manager 250 may create a provisioning order, based on the service specific TIO received from order gateway 240, and may provide the provisioning order. In some implementations, order manager 250 may create the provisioning order when order manager 250 receives the service specific TIO from order gateway 240 (e.g., after order manager 250 receives the service specific TIO). Additionally, or alternatively, order manager 250 may create the provisioning order when order manager 250 receives information, indicating that order manager 250 is to create the provisioning order, from another device (e.g., order gateway 240).

In some implementations, order manager 250 may create the provisioning order in an expedited manner. For example, order manager 250 may receive the service specific TIO, and may create the provisioning order approximately immediately after order manager 250 receives the service specific TIO (e.g., in real-time). As an additional example, order manager 250 may create the provisioning order in an expedited manner by prioritizing the service specific TIO such that the provisioning order is created without placing the service specific TIO in a queue.

Additionally, or alternatively, order manager 250 may determine whether order manager 250 may forego performing a task (e.g., a task associated with processing a non-TIO), in order to create the provisioning order in an expedited manner. For example, order manager 250 may determine that order manager 250 may forego validating a customer address, associated with the service specific TIO, since the technician is on the customer premises (e.g., when the customer address was already validated in order to bring the technician to the customer premises). As such, foregoing the performance of the task may allow the provisioning order to be created in an expedited manner.

A provisioning order may include an order, created by order manager 250, associated with initiating provisioning of a service identified in a service specific TIO. For example, order manager 250 may receive a service specific TIO that identifies a service to be provided to a customer, may determine information associated with initiating provisioning of the service (e.g., a switch to be used to provide the service, a drop box to be used to provide the service, a port to be used to provide the service, etc.), and may create a provisioning order that includes the information associated with initiating provisioning of the service. Additionally, order manager 250 may determine and apply billing information and/or other order information when creating the provisioning order (e.g., to ensure integrity of the information included in the service specific order).

Additionally, or alternatively, the provisioning order may include information (e.g., an indicator, a flag, a tag, a label, etc.) indicating that the provisioning order is based on a TIO (e.g., such that provisioning device 260 may identify the provisioning order as a TIO).

In some implementations, order manger 250 may create the provisioning order, and order manager 250 may provide the provisioning order. For example, order manger 250 may create the provisioning order and may provide the provisioning order to provisioning device 260.

As further shown in FIG. 4, process 400 may include acknowledging receipt of the provisioning order (shown at reference number 435). For example, provisioning device 260 may receive the provisioning order, provided by order manager 250, and provisioning device 260 may acknowledge receipt of the provisioning order. In some implementations, provisioning device 260 may acknowledge receipt of the provisioning order when provisioning device 260 receives the provisioning order (e.g., after provisioning device 260 receives the provisioning order).

In some implementations, provisioning device 260 may acknowledge receipt of the provisioning order in an expedited manner. For example, provisioning device 260 may receive the provisioning order, may identify (e.g., based on information included in the provisioning order) the provisioning order as a TIO, and may send an acknowledgment of receipt of the provisioning order to order manager 250. In this example, order manager 250 may receive the acknowledgement, and may provide the acknowledgment to order gateway 240. Order gateway 240 may receive the acknowledgment, and may provide the acknowledgment to order device 230. Order device 230 may receive the acknowledgment, and may provide the acknowledgment to technician device 210.

In this way, the technician, associated with technician device 210, may provide order information associated with providing a service to a customer, the order information may be provided to provisioning device 260 (e.g., in the form of a provisioning order), and technician device 210 may receive an acknowledgment indicating that the order information has been received by provisioning device 260. This may allow the technician, associated with technician device 210, to confirm that the order information has been received and is being processed.

In some implementations, technician device 210 may receive the acknowledgement shortly after providing the order information (e.g., since order device 230, order gateway 240, order manager 250, and provisioning device 260 may act in an expedited manner, as discussed above). For example, technician device 210 may provide the order information, and may receive the acknowledgment in less than approximately one minute, two minutes, or five minutes, etc., after providing the order information (e.g., when order device 230, order gateway 240, order manager 250, and provisioning device 260 each process the order in an expedited manner).

As further shown in FIG. 4, process 400 may include determining provisioning information based on the provisioning order (shown at reference number 440). For example, provisioning device 260 may determine provisioning information based on the provisioning order received from order manager 250. In some implementations, provisioning device 260 may determine the provisioning information when provisioning device 260 receives the provisioning order from order manager 250. Additionally, or alternatively, provisioning device 260 may determine the provisioning information when provisioning device 260 acknowledges receipt of the provisioning order (e.g., after provisioning device 260 provides the acknowledgment of receipt to order manager 250).

Provisioning information may include information, to be provided to a technician, associated with initiating provisioning of a service to a customer. For example, the provisioning information may include information that identifies a piece of equipment (e.g., an equipment type, an equipment model, etc.) to be installed at the customer premises, information associated with installing the piece of equipment (e.g., installation instructions, configuration instructions, etc.), information provided by order manager 250 (e.g., the switch to be used to provide the service, the drop box to be used to provide the service, the port to be used to provide the service, etc.), or another kind of information that may be used by the technician to physically install and/or configure the piece of equipment.

In some implementations, provisioning device 260 may determine the provisioning information in an expedited manner. For example, provisioning device 260 may receive the provisioning order, may determine (e.g., based on information included in the provisioning order) that the provisioning order is a TIO, and may immediately determine the provisioning information (e.g., in real-time). As an additional example, provisioning device 260 may determine the provisioning information in an expedited manner by prioritizing (e.g., based on identifying the provisioning order as a TIO) the provisioning order such that the provisioning information is determined without placing the provisioning order in a queue.

As further shown in FIG. 4, process 400 may include providing the provisioning information (shown at reference number 445). For example, provisioning device 260 may provide the provisioning information to technician device 210. In some implementations, provisioning device 260 may provide the provisioning information when provisioning device 260 determines the provisioning information (e.g., after provisioning device 260 determines the provisioning information). Additionally, or alternatively, provisioning device 260 may provide the provisioning information when provisioning device 260 receives information, indicating that provisioning device 260 is to provide the provisioning information, from another device (e.g., order manager 250).

In some implementations, provisioning device 260 may provide the provisioning information to technician device 210 (e.g., via network 220 and/or one or more other devices included in environment 200). In some implementations, technician device 210 may receive the provisioning information shortly after providing the order information (e.g., since provisioning device 260 may determine the provisioning information in an expedited manner, as discussed above). For example, technician device 210 may provide the order information, and may receive the provisioning information approximately ten minutes, twenty minutes, or thirty minutes, etc., after providing the order information. In this way, a technician, located on a customer premises, may provide order information associated with providing a service, and the technician may install and/or configure a piece of equipment (e.g., based on the provisioning information) while the technician is on the customer premises (e.g., without the need to return to the customer premises a second time). In other words, the technician may place the customer order, associated with the service, and may install and/or configure equipment, and initiate provisioning of the service in a single visit to the customer premises. In some implementations, technician device 210 may receive the provisioning information, the technician may view the provisioning information, and the technician may install and/or configure a piece of equipment, identified in the provisioning information, associated with providing the service.

As further shown in FIG. 4, process 400 may include receiving an indication that an installation and/or a configuration, associated with providing the service, is complete (shown at reference number 450). For example, provisioning device 260 may receive an indication that an installation of a piece of equipment and/or configuration of the piece of equipment, associated with providing a service and identified in the provisioning information, is complete. In some implementations, provisioning device 260 may receive the indication based on information provided by the technician. For example, the technician may install a piece of equipment as described by the provisioning information provided by provisioning device 260, the technician may provide, to technician device 210, input indicating that the installation is complete, and technician device 210 may provide the information to provisioning device 260 (e.g., via network 220 and/or one or more other devices included in environment 200). In some implementations, provisioning device 260 may initiate provisioning of the service based on receiving the information indicating that the installation and/or the configuration is complete (e.g., since all installation and/or configuration is complete and provisioning information is known).

As further shown in FIG. 4, process 400 may include providing an indication that provisioning of the service is complete based on receiving the indication that the installation and/or the configuration is complete (shown at reference number 455). For example, provisioning device 260 may provide an indication that provisioning of the service is complete based on receiving the indication that the installation and/or the configuration is complete. In some implementations, provisioning device 260 may provide the indication when provisioning device 260 receives the information indicating that the installation and/or the configuration is complete. Additionally, or alternatively, provisioning device 260 may provide the indication when provisioning device 260 initiates provisioning of the service (e.g., after the service begins to be provided to the customer premises via the piece of installed equipment).

In some implementations, the indication may include information, provided to order manager 250, indicating that billing for the service may begin. For example, provisioning device 260 may initiate provisioning of the service to the customer premises, and provisioning device 260 may provide, to order manager 250, an indication that provisioning of the service is complete, and that billing for the service may begin.

As further shown in FIG. 4, process 400 may include providing billing information based on receiving the indication that the provisioning of the service is complete (shown at reference number 460). For example, order manager 250 may provide billing information based on receiving the indication that provisioning of the service is complete. In some implementations, order manager 250 may provide the billing information when order manager 250 receives, from provisioning device 260, the indication indicating that provisioning of the service is complete.

Billing information may include information associated with billing the customer for the service and/or for provisioning of the service. For example, billing information may include information associated with the customer (e.g., a customer identifier, a customer account number, etc.), information associated with the customer premises (e.g., a street address, a city, a state, a telephone number, etc.), information associated with the service (e.g., a type of service, a billing rate associated with the service, etc.), or another type of billing information. In some implementations, order manager 250 may create the billing information (e.g., based on the indication received from provisioning device 260, based on information associated with the provisioning order stored by order manager 250, etc.). In some implementations, order manager 250 may provide the billing information to billing device 270, and billing device 270 may begin billing the customer for the service.

Although FIG. 4 shows example operations of process 400, in some implementations, process 400 may include additional operations, different operations, fewer operations, or differently arranged operations than those depicted in FIG. 4. Additionally, or alternatively, one or more of the operations of process 400 may be performed in parallel.

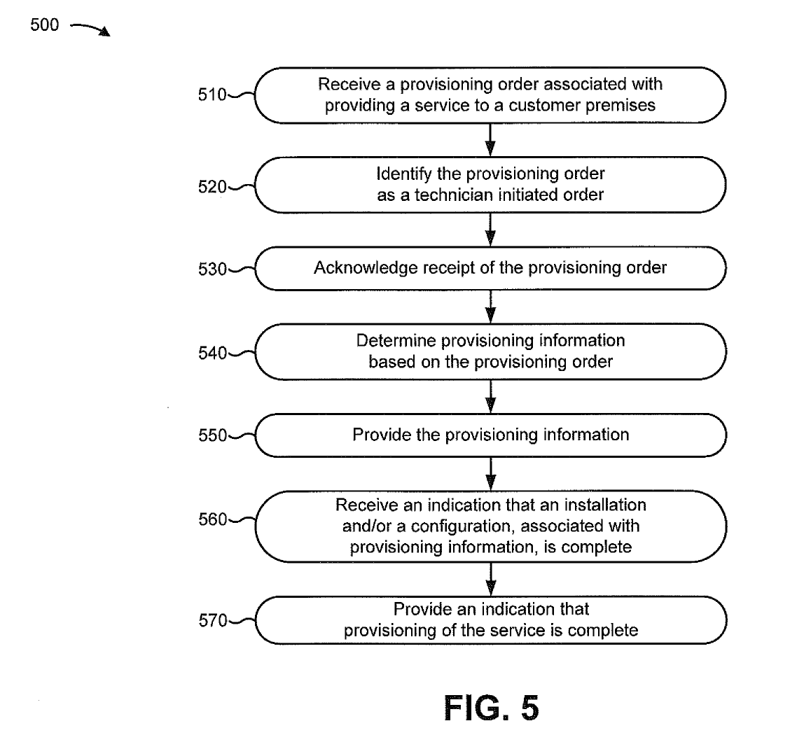

FIG. 5 is a flow chart of an example process 500 for receiving a provisioning order and completing provisioning of a service, associated with the provisioning order, in an expedited manner. In some implementations, one or more process blocks of FIG. 5 may be performed by provisioning device 260. In some implementations, one or more process blocks of FIG. 5 may be performed by another device or a group of devices separate from or including provisioning device 260, such as order manager 250 or another device included in environment 200.

As shown in FIG. 5, process 500 may include receiving a provisioning order associated with providing a service to a customer premises (block 510). For example, provisioning device 260 may receive a provisioning order associated with providing a service to a customer premises, as discussed above.

As further shown in FIG. 5, process 500 may include identifying the provisioning order as a TIO (block 520). For example, provisioning device 260 may identify the provisioning order as a TIO. In some implementations, provisioning device 260 may identify the provisioning order as a TIO based on information included in the provisioning order, as discussed above.

As further shown in FIG. 5, process 500 may include acknowledging receipt of the provisioning order (block 530). For example, provisioning device 260 may acknowledge receipt of the provisioning order, as discussed above.

As discussed, in some implementations, provisioning device 260 may acknowledge receipt of the provisioning order in an expedited manner, such that technician device 210, associated with the provisioning order, may receive the acknowledgement of receipt in less than approximately one minute after technician device 210 provides order information associated with the provisioning order.

As further shown in FIG. 5, process 500 may include determining provisioning information based on the provisioning order (block 540). For example, provisioning device 260 may determine provisioning information based on the provisioning order, as discussed above.

As discussed, in some implementations, provisioning device 260 may determine the provisioning information in an expedited manner, such that provisioning device 260 may provide, to technician device 210, the provisioning information in less than approximately fifteen minutes after technician device 210 provides the order information associated with the provisioning order.

As further shown in FIG. 5, process 500 may include providing the provisioning information (block 550). For example, provisioning device 260 may provide the provisioning information to technician device 210 (e.g., via one or more devices included in environment 200). In some implementations, a technician, associated with technician device 210, may install and/or may configure a piece of equipment, associated with providing the service, as discussed above.

As further shown in FIG. 5, process 500 may include receiving an indication that an installation and/or a configuration, associated with the provisioning information, is complete (block 560). For example, provisioning device 260 may receive an indication, provided by technician device 210, that an installation and/or configuration, associated with the provisioning information, is complete, as discussed above.

As further shown in FIG. 5, process 500 may include providing an indication that provisioning of the service is complete (block 570). For example, provisioning device 260 may provide, to order manager 250, an indication that provisioning of the service, associated with the provisioning order, is complete. As discussed, provisioning device 260 may provide the indication to allow billing for provisioning of the service to begin.

Although FIG. 5 shows example blocks of process 500, in some implementations, process 500 may include additional blocks, different blocks, fewer blocks, or differently arranged blocks than those depicted in FIG. 5. Additionally, or alternatively, one or more of the blocks of process 500 may be performed in parallel.

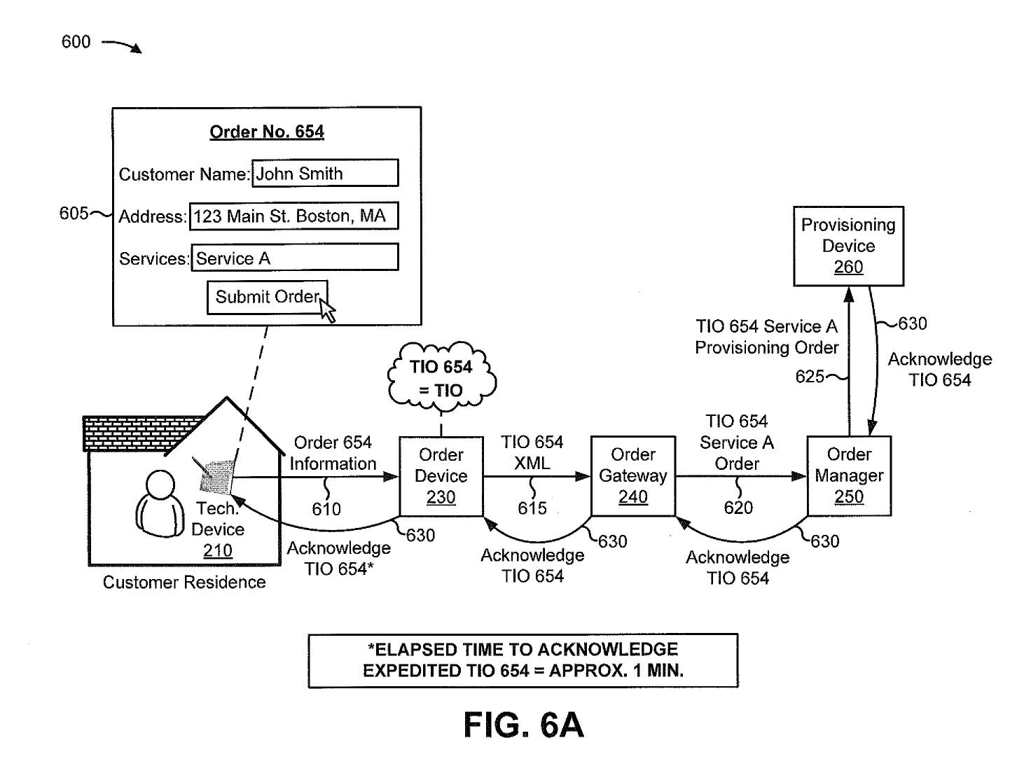

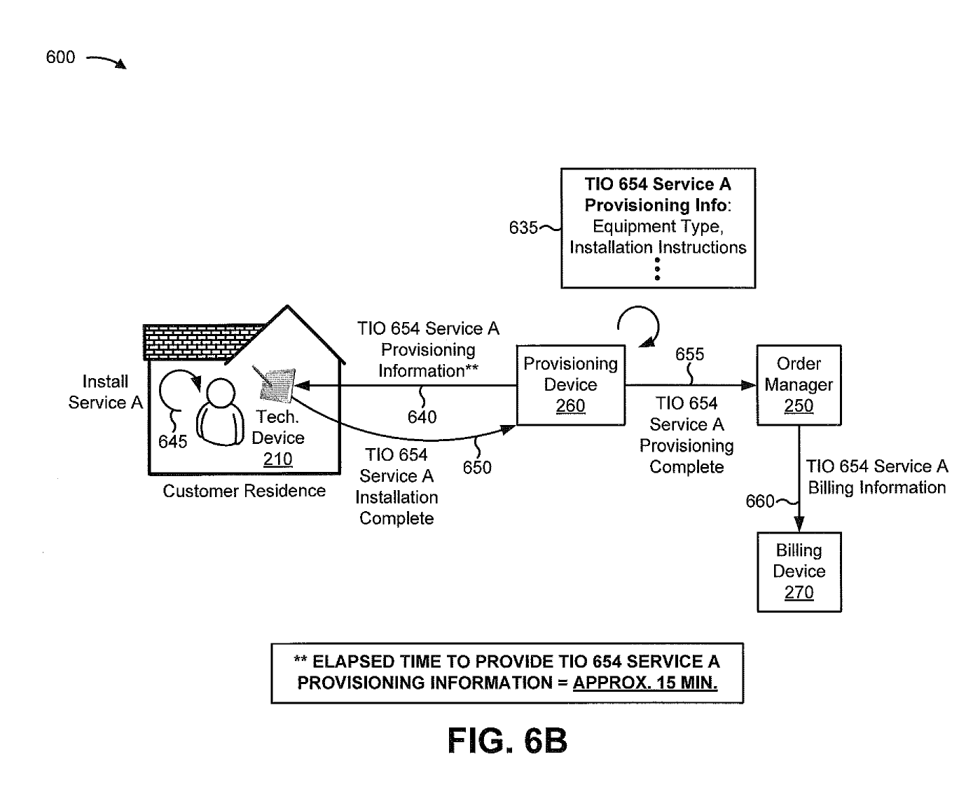

FIGS. 6A and 6B are diagrams of an example implementation 600 relating to example processes 400 and 500 shown in FIG. 4 and FIG. 5, respectively. For the purposes of example implementation 600, assume that a technician, associated with a service provider, is on a customer premises (e.g., a customer residence). Further, assume that the customer chooses to order a new service (e.g., a service not currently provided to the customer residence) while the technician is on the customer premises. Finally, assume that the technician may provide order information, associated with the service, to technician device 210 for expedited order processing by one or more devices in a service provider network.

As shown in FIG. 6A, and by reference number 605, the technician may provide, via a user interface displayed on display screen of technician device 210, order information associated with providing the service. As shown technician device 210 may assign an order number to the order information (e.g., Order No. 654). As further shown, the technician may provide a customer name, (e.g., John Smith), a customer address (e.g., 123 Main Street, Boston, Mass.), and information associated with the service to be provided (e.g., Service Type A), and other order information (not shown). As shown, the technician may cause technician device 210 to provide the order information for processing by selecting a “Submit Order” button.

As shown by reference number 610, technician device 210 may provide the order 654 information to order device 230. As shown, order device 230 may receive the order 654 information and may identify the order 654 information as a TIO (e.g., since order device 230 received the order information from technician device 210), and order device 230 may create a formatted TIO 654 (e.g., TIO 654 XML) based on identifying the order 654 information as a TIO. For the purposes of example implementation 600, assume that devices associated with processing a TIO are configured to process the order in an expedited manner (e.g., without using a queue system to process the order).

As shown by reference number 615, order device 230 may provide the TIO 654 XML to order gateway 240. Order gateway 240 may receive the TIO 654 XML, and may create a service specific TIO (e.g., TIO 654 service A Order). As shown by reference number 620, order gateway 240 may provide the TIO 654 service A order to order manager 250 (e.g., assume that order manager 250 is configured to manage orders associated with service A). Order manager 250 may receive the TIO 654 service A order, and may create a TIO 654 service A provisioning order. As shown by reference number 625, order manager 250 may provide the TIO 654 service A provisioning order to provisioning device 260.

As shown by reference number 630, provisioning device 260 may acknowledge receipt of the TIO 654 service A provisioning order, and the acknowledgment of receipt may be provided to order manager 250, order gateway 240, order device 230, and technician device 210. As shown, the elapsed time from technician device 210 providing the order information to technician device 210 receiving the acknowledgement of receipt may be less than approximately one minute (e.g., since order 654 was processed in an expedited manner).

As shown in FIG. 6B, and by reference number 635, provisioning device 260 may determine provisioning information based on the TIO service A provisioning order. As shown, provisioning device 260 may determine an equipment type associated with the TIO service A provisioning order, may determine installation instructions associated with the TIO service A provisioning order, and may determine other information associated with initiating provisioning of service A to the customer residence. As shown by reference number 640, provisioning device 260 may provide the TIO service A provisioning information to technician device 210. As shown, the elapsed time from technician device 210 providing the order information to technician device 210 receiving the provisioning information may be less than approximately fifteen minutes (e.g., since provisioning device 260 determines TIO service A provisioning information in an expedited manner).

As shown by reference number 645, the technician may view the provisioning information (e.g., received by technician device 210), and the technician may install the equipment, associated with providing service A to the customer premises, based on the TIO service A provisioning information (e.g., while the technician is still on the customer premises). The technician may complete the installation, may provide, via technician device 210, information indicating that the installation of the TIO 564 service A equipment is complete, and, as shown by reference number 650, technician device 210 may provide the indication to provisioning device 260. As shown by reference number 655, provisioning device 260 may provide information, indicating the provisioning of the service is complete, to order manager 250. As shown by reference number 660, order manager 250 may provide billing information, associated with billing the customer for service A, to billing device 270.

As indicated above, FIGS. 6A and 6B are provided merely as an example. Other examples are possible and may differ from what was described with regard to FIGS. 6A and 6B.

Implementations described herein may allow a service technician, located on a customer premises, to initiate an order, associated with providing a service to the customer, and may allow provisioning of the service to be completed in an expedited manner (e.g., while the service technician is on the customer premises).

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Certain user interfaces have been described herein. In some implementations, the user interfaces may be customizable by a device or a user. Additionally, or alternatively, the user interfaces may be pre-configured to a standard configuration, a specific configuration based on a type of device on which the user interfaces are displayed, or a set of configurations based on capabilities and/or specifications associated with a device on which the user interfaces are displayed.

To the extent the aforementioned implementations collect, store, or employ personal information provided by individuals, it should be understood that such information shall be used in accordance with all applicable laws concerning protection of personal information. Storage and use of personal information may be in an appropriately secure manner reflective of the type of information, for example, through various encryption and anonymization techniques for particularly sensitive information.

It will be apparent that systems and/or methods, as described herein, may be implemented in many different forms of software, firmware, and hardware in the implementations shown in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A device, comprising:
one or more processors to:
receive a provisioning order associated with providing a service to a customer premises,
the provisioning order being based on order information, provided by a technician located on the customer premises, associated with initiating provisioning of the service to the customer premises;
identify the provisioning order as a prioritized order,
the provisioning order being identified as a prioritized order indicating that the provisioning order is to be processed before a non-prioritized provisioning order;
provide an acknowledgement of receipt of the provisioning order based on identifying the provisioning order as a prioritized order;
determine provisioning information based on the provisioning order,
the provisioning information including equipment installation or configuration instructions associated with initiating provisioning of the service to the customer premises; and
provide the provisioning information while the technician is located on the customer premises.

2. The device of claim 1, where the one or more processors are further to:
identify the provisioning order as being associated with a technician initiated order; and
where the one or more processors, when identifying the provisioning order as a prioritized order, are further to:
identify the provisioning order as a prioritized order based on identifying the provisioning order as being associated with a technician initiated order.

3. The device of claim 1, where the one or more processors, when providing the acknowledgement of receipt, are further to:
provide the acknowledgment of receipt for display on a technician device, associated with the technician, less than approximately one minute after the provisioning order is received.

4. The device of claim 1, where the one or more processors, when providing the provisioning information, are further to:
provide the provisioning information for display on a technician device, associated with the technician, less than approximately fifteen minutes after the provisioning order is received.

5. The device of claim 1, where the one or more processors, when providing the acknowledgment of receipt, are further to:
provide the acknowledgment of receipt to a technician device,
the technician device being associated with the technician and being located on the customer premises.

6. The device of claim 1, where the one or more processors, when providing the provisioning information, are further to:
provide the provisioning information such that the technician can view the equipment installation or configuration instructions and install or configure equipment, associated with the equipment installation or configuration instructions, while located on the customer premises.

7. The device of claim 1, where the one or more processors are further to:
receive an indication that equipment installation or configuration, associated with the equipment installation or configuration instructions, is complete; and
provide information indicating that provisioning of the service is complete based on receiving the indication.

8. A computer-readable medium storing instructions, the instructions comprising:
one or more instructions that, when executed by one or more processors, cause the one or more processors to:
receive a provisioning order associated with a service to be provided to a customer premises,
the provisioning order being based on order information associated with initiating provisioning of the service to the customer premises,
the order information being provided by a technician located on the customer premises;
determine that the provisioning order is a prioritized order,
the provisioning order being a prioritized order indicating that the provisioning order is to be processed before one or more non-prioritized provisioning orders that have been received prior to the provisioning order;
send an acknowledgement of the provisioning order based on determining that the provisioning order is a prioritized order;
determine provisioning information based on the provisioning order,
the provisioning information including configuration instructions associated with initiating provisioning of the service to the customer premises; and
send the provisioning information while the technician is located on the customer premises.

9. The computer-readable medium of claim 8, where the one or more instructions, when executed by the one or more processors, further cause the one or more processors to:
identify the provisioning order as being associated with a technician initiated order; and
where the one or more instructions, that cause the one or more processors to determine that the provisioning order is a prioritized order, further cause the one or more processors to:
determine that the provisioning order is a prioritized order based on identifying the provisioning order as being associated with a technician initiated order.

10. The computer-readable medium of claim 8, where the one or more instructions, that cause the one or more processors to send the acknowledgement, further cause the one or more processors to:
send the acknowledgment for display on a technician device, associated with the technician, less than approximately five minutes after the provisioning order is received.

11. The computer-readable medium of claim 8, where the one or more instructions, that cause the one or more processors to send the provisioning information, further cause the one or more processors to:
send the provisioning information for display on a technician device, associated with the technician, less than approximately thirty minutes after the provisioning order is received.

12. The computer-readable medium of claim 8, where the one or more instructions, that cause the one or more processors to send the acknowledgment, further cause the one or more processors to:
send the acknowledgment to a technician device,
the technician device being associated with the technician and being located on the customer premises.

13. The computer-readable medium of claim 8, where the one or more instructions, that cause the one or more processors to send the provisioning information, further cause the one or more processors to:
send the provisioning information such that the technician can view the configuration instructions and configure equipment, associated with the configuration instructions, while located on the customer premises.

14. The computer-readable medium of claim 8, where the one or more instructions, when executed by the one or more processors, further cause the one or more processors to:
receive an indication that a configuration, associated with the configuration instructions, is complete; and
provide information indicating that provisioning of the service is complete based on receiving the indication.

15. A method, comprising:
receiving, by a device, a provisioning order associated with providing a service to a customer premises,
the provisioning order being based on information, provided by a technician located on the customer premises, associated with initiating provisioning of the service to the customer premises;
identifying, by the device, the provisioning order as a prioritized order,
the provisioning order being identified as a prioritized order indicating that the provisioning order is to be processed in an expedited manner relative to a non-prioritized provisioning order;
acknowledging, by the device, receipt of the provisioning order based on identifying the provisioning order as a prioritized order;
determining, by the device, provisioning information based on information included in the provisioning order,
the provisioning information including instructions associated with initiating provisioning of the service to the customer premises; and
providing, by the device, the provisioning information while the technician is located on the customer premises.

16. The method of claim 15, further comprising:
identifying the provisioning order as being associated with a technician initiated order; and
where identifying the provisioning order as a prioritized order further comprises:
identifying the provisioning order as a prioritized order based on identifying the provisioning order as being associated with a technician initiated order.

17. The method of claim 15, where acknowledging receipt of the provisioning order further comprises:
acknowledging receipt of the provisioning order by providing an acknowledgement of receipt for display on a technician device, associated with the technician, less than approximately two minutes after the provisioning order is received.

18. The method of claim 15, where providing the provisioning information further comprises:
providing the provisioning information for display on a technician device, associated with the technician, less than approximately twenty minutes after the provisioning order is received.

19. The method of claim 15, further comprising:
providing the provisioning information such that the technician can view the instructions and install equipment or configure equipment, associated with the instructions, while located on the customer premises.

20. The method of claim 15, further comprising:
receiving an indication that an installation or a configuration, associated with the instructions, is complete; and
providing information indicating that provisioning of the service is complete based on receiving the indication.
